(19) United States
(12) Patent Application Publication
(10) Pub. No.: US 2010/0109332 A1
(43) Pub. Date: May 6, 2010

(54) Floating electricity generating plant

(76) Inventor: Frank Del Valle, Croton On Hudson, NY (US)

Correspondence Address: Frank del Valle, 28 Westminster Dr., Crotonon Hudson, NY, 10520, US

(21) Appl. No.: 12/290,993

(22) Filed: Nov. 6, 2008

(51) Int. Cl. F03B 13/00

(52) U.S. Cl. 290/54

(57) ABSTRACT

The purpose of this invention is to produce Electricity from running surface water by the use of a water wheel mounted on a Floating platform and coupled to a Generator assembly. The invention specifically uses already known technologies and existing equipment, in a novel combination to create a versatile floating power plant.

### BACKGROUND

While the production of inexpensive, uninterrupted and reliable electrical power is a subject of interest worldwide, the availability of energy from water streams has not been properly tapped.

The use of water wheels is well documented and goes back to before Babylonian times. This source of energy was utilized by subsequent civilizations, from ancient Greece and Rome to modern Europe and America to power mills of different type.

In those, the wheels were attached to the structures which housed the mills This invention, however, utilizes the same type of technology on potentially variable water courses as a continuous source of energy and would not depend on a leveled water volume for its performance, as required with fixed structures.

The invention is a movable system capable of being relocated to appropriate sites, and self-adjusting to maximize electrical output.

### BRIEF SUMMARY

This invention specifically refers to the utilization of the ancient use of the water wheels to produce hydraulic energy, and convert it to Electricity by coupling it to an AC or DC current generator (s).

The most novel part of the invention is the use of a floating platform to support the wheel and the electricity generating equipment, thereby allowing for the rise or fall of the level of the flowing water. Said platform would be anchored or secured by pylons at the appropriate sites in rivers, dams, or other available surface running water sources.

Other methods for obtaining electricity utilizing hydraulic power have been proposed, e g: tunneling, dams, tidal basins, etc., which required large and expensive installations as well as disruption of land and property.

By contrast this invention may be constructed at a minimal cost and with virtually no disruption to the environment. I can be sized individually or in connection with multiple platforms to meet local energy requirements.

### DESCRIPTION OF DRAWINGS

FIG. 1: The drawing shows the dimensions for a half platform holding an eleven foot radius wheel. A mirror image half platform, placed opposite to the one shown in FIG. 1B to form the throat necessary for the wheel to rotate freely.

FIG. 1B: View and dimensions of the platform

FIG. 2: View of the wheel mounted on partial platform and, consisting of at least sixteen spokes,

FIG. 3: Dimensions of the wheel spokes and paddles

FIG. 3A: Frontal view of the paddle

FIG. 3B: Lateral view of the paddle

FIG. 4: Siemens brand generator assembly

FIG. 5: General Electric brand generator assembly

FIG. 6: Generator Assembly coupled to Wheel's axle.

### DESCRIPTION

### Field of the Invention

The invention refers to the production of Electricity by a power plant mounted on a floating platform, whereas mechanical energy is provided by running water and is harnessed by a water wheel. The Electric energy is produced by Generators attached to the wheel's axle

This invention has the unique advantage of utilizing existing water courses without disturbing the topography of the surrounding environment. The power plant can be adapted by size and output to the site selected and, in contrast with wind mills and solar panels, the water current will provide a constant and even steam of electricity production; the flow of water will remain even whether is calm or it is night.

### Description

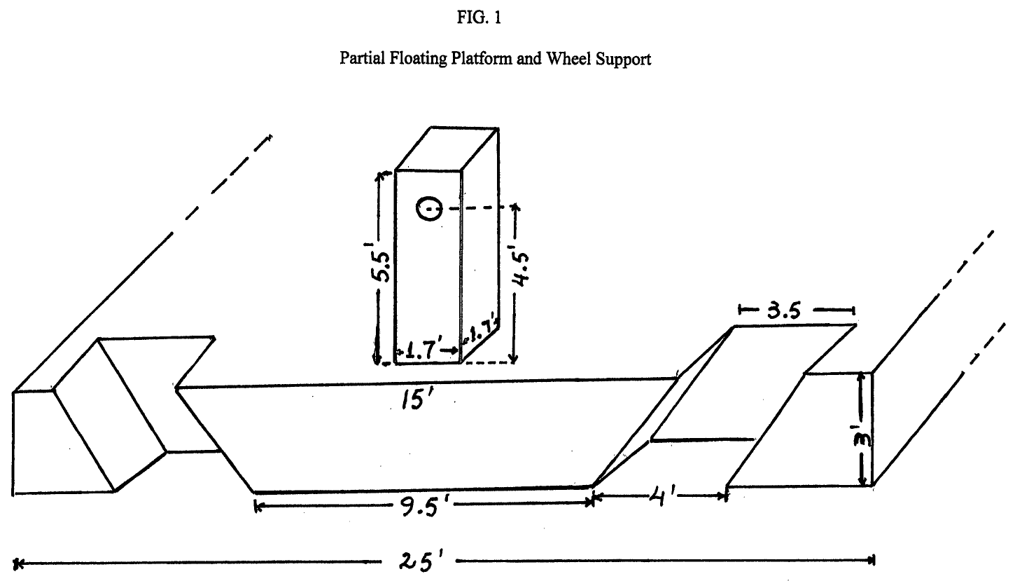

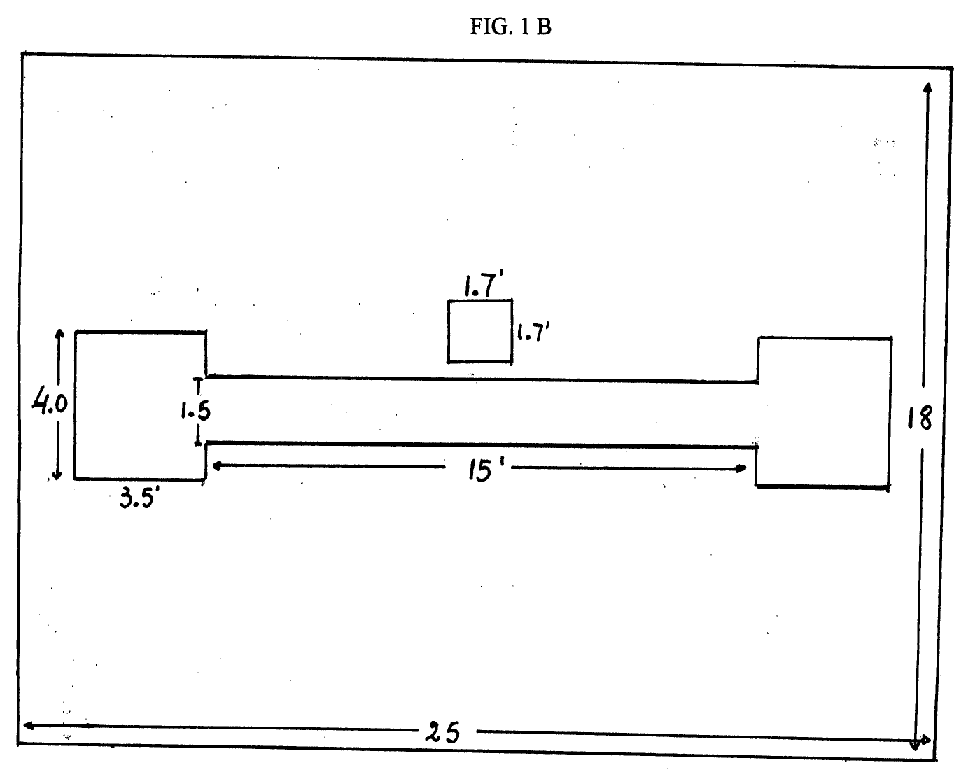

FIG. 1 shows a floating platform which is supported by pontoons or any other adequate plastic or metallic floating devices. An adequate throat is made to allow for the free movement of the wheel through the platform. FIGS. 1 and 1B.

Four adjustable “legs”, of adequate length, are attached to the corners of the platform. These prevent the wheels from touching the river's bed in the unlikely event that the water level falls below the required for operation.

The wheel is mounted on the platform using two pillars; one at each side of the throat. The wheel's axle goes through them and serves as the power source for AC or DC generator(s)

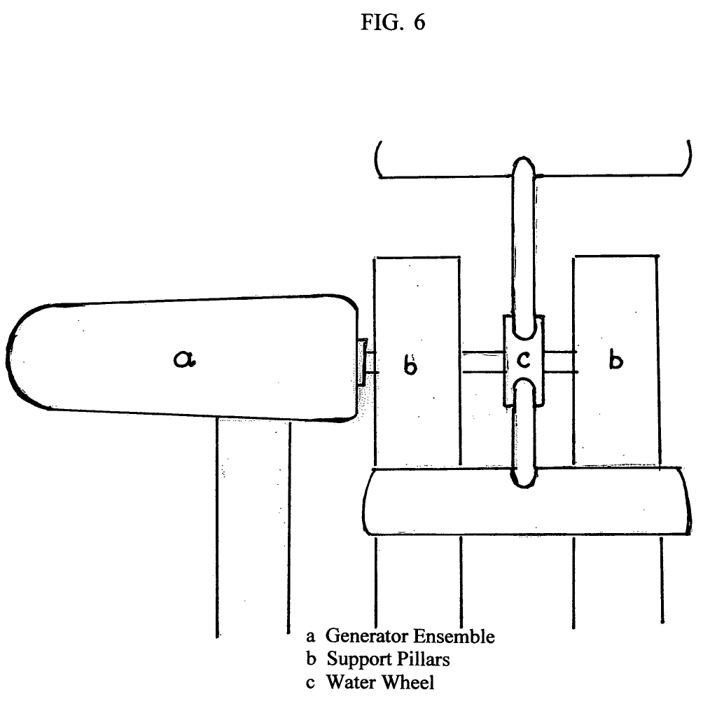

Electricity generator assemblies are coupled to the axle. (FIG. 6) The number of generators attached to the wheel can vary depending on the size of the overall structure and the design of the main gear, which could accommodate one or more generators.

These assemblies are commercially available and used in wind mills, they can readily be adapted for use in the proposed invention by replacing the propellers with a coupling and connecting the assemblies to the wheel's axle.

The size and output of the power system, including the wheel and platform, are limitless, and can be tailored to fit the stream where it would be utilized, output can be further increased by connecting multiple systems in series.

The Wheel designed and presented in this paper represents one of many possible variations, including traditional water wheels.

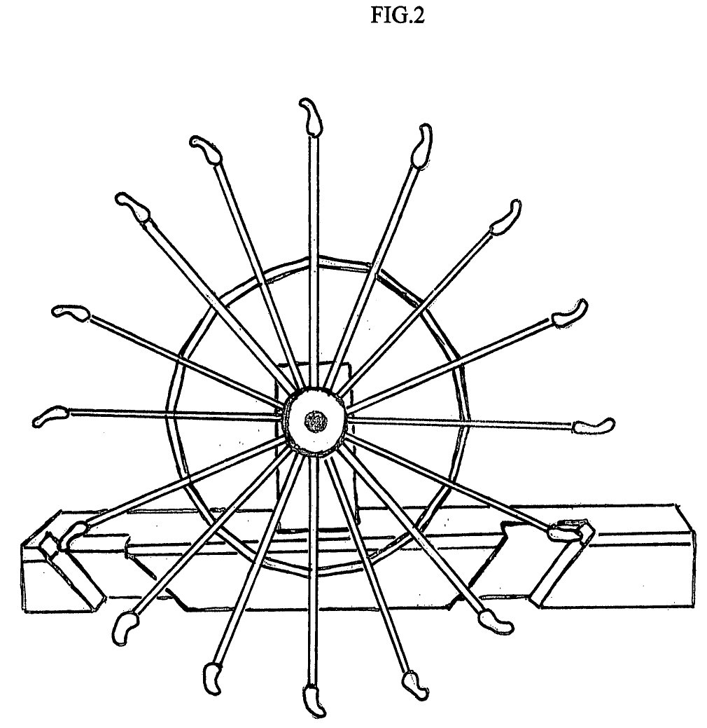

The wheel presented in (FIG. 2) is preferred for its strength, simplicity and its lighter weight as compared to traditional water wheels. The strength is provided by virtue of modern construction materials, such as Aluminum, Steel (Coated with PVC or other plastic water proof materials) Fiberglass, etc.

FIG. 2 shows a prototype of the wheel, in this case consisting of sixteen spokes, which can be increased if deemed necessary to fit the stream flow characteristics.

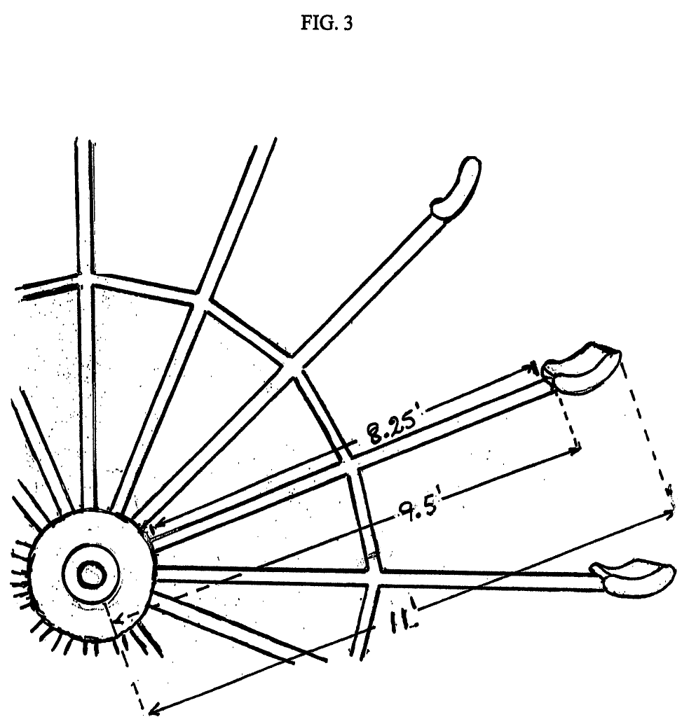

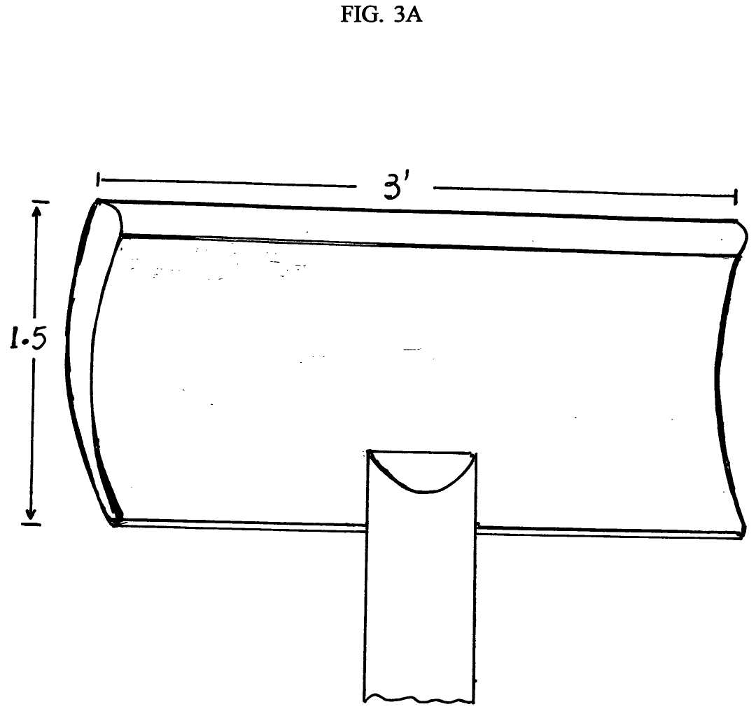

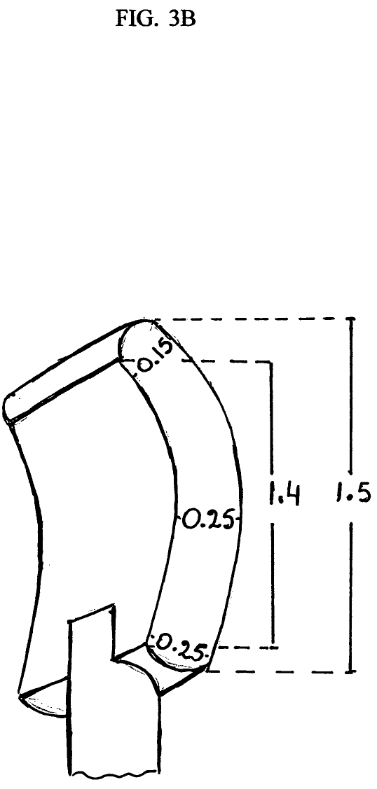

The paddles are also constructed with the same materials and have a concave shape to maximize the water's “pushing” effect. (FIG. 3B)

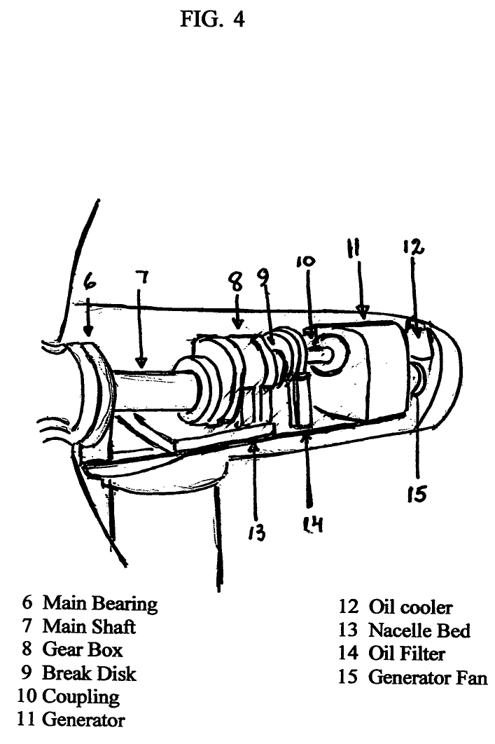

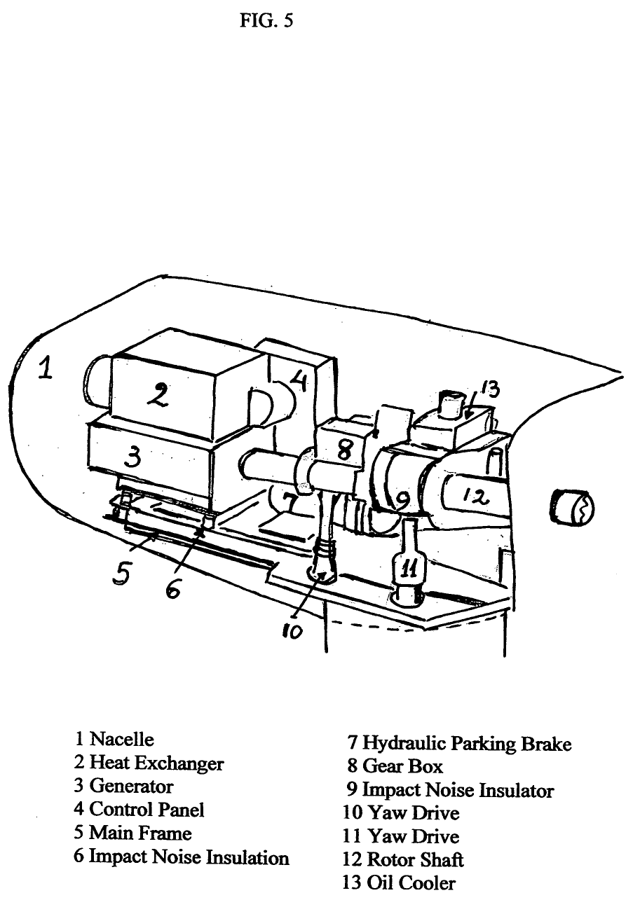

The generators mentioned in this discussion are of the type currently utilized in wind mills. The examples provided are manufactured by Siemens (FIG. 4) and General Electric, (FIG. 5). They are complete assemblies, include monitoring and control of the electricity load. It is not the purpose of this invention to endorse the usage of any specific generator but to establish the connection between water power and electricity generation in a versatile and convenient floating power plant.

The inventor envisions the utility of the plant, at a fraction of the cost of other alternative non polluting power sources, limited maintenance cost and the possibility to swiftly relocate the outfit to areas of need in the event of meteorological calamities.

The inventor also realizes that engineering expertise will be necessary to perfect the fitting of the working parts of the plant, in conformity with its design.

1) The main claim of this invention is the unique combination of a Floating platform, a water wheel and a Electricity generating Plant composed of
a) A platform made buoyant by means of pontoon, or any other means of flotation
b) A throat placed either in the middle or towards a side of the platform depending on the final-power plant configuration, to allow for the free rotation of the wheel
c) A Water Wheel which design may either conform to that suggested in this paper, or any other available design pertinent to the purpose
d) One or more Electricity generators
e) Protective adjustable legs.

2) Use of a Water Wheel as the power source for an electricity generation plant

3) Use of commercially available AC or DC Generators ensembles connected to the water wheel.
